(19) United States
(12) Patent Application Publication
(10) Pub. No.: US 2010/0075795 A1
(43) Pub. Date: Mar. 25, 2010

(54) CROWN GEAR AND DIFFERENTIAL ASSEMBLY WITH A CROWN GEAR

(76) Inventors: Werner Krude, Neunkirchen-Seelscheid (DE); Ralf Leuschen, Oberbettingen (DE); Michael Engelmann, St. Augustin (DE)

Correspondence Address: GKN Driveline/TTG, c/o Kristin L. Murphy, 39533 Woodward Avenue, suite 140, Bloomfield Hills, MI, 48304, US

(21) Appl. No.: 11/915,568

(22) PCT Filed: Apr. 8, 2006
(86) PCT No.: PCT/EP2006/003226

§ 371 Date: Sep. 15, 2008

(30) Foreign Application Priority Data
May 24, 2005 (DE) 10 2005 024455.6

(51) Int. Cl. F16H 48/06; F16H 1/12

(52) U.S. Cl. 475/220; 74/416

(57) ABSTRACT

The invention relates to a crown gear (2) which can engage a spur gear (201 ), and to a differential assembly (25) in the form of a crown gear differential for the driveline of a motor vehicle. The crown gear (2) comprises an annular toothing portion (3) forming a crown toothing (6), and a hub (4) axially projecting beyond the crown toothing (6). Between the crown toothing (6) and the hub (4) there are formed transition portions (12) which adjoin addendum lines (8) of the crown toothing (6) and change into the hub (4).

The invention relates to a crown gear, more particularly to a differential assembly for the driveline of a motor vehicle as well as to a differential assembly in the form of a crown gear differential.

From EP 1 203 900 A2 there is known a crown gear differential with a differential carrier and two sideshaft gears in the form of crown gears arranged in the differential carrier on an axis of rotation, and with a plurality of differential gears in the form of spur gears which meshingly engage the crown gears. The differential gears are rotatably supported on journals of a star-shaped supporting element which rotates together with the differential carrier. The crown gears comprise a toothed portion and a hub which is axially set back relative to the latter and into which it is possible to insert a sideshaft for torque transmitting purposes.

DE 103 54 998 A1 shows a similar crown gear differential wherein the sideshaft gears are provided in the form of crown gears and comprise an annular toothed portion and a hub integrally produced therewith. The hub axially extends beyond the toothed portion and partially projects into a central bore of the journal star. The transition between the root lines of the teeth and the hub is rounded.

From PCT/EP2004/009607 there is known a limited slip differential in the form of a crown gear differential wherein the sideshaft gears are provided in the form of crown gears. The crown gears comprise a cylindrical hub to which an annular toothed portion is connected approximately centrally, with reference to the axial extension of the hub. Between the teeth and the cylindrical outer face of the hub, there is provided an annular undercut.

EP 787 055 B1 proposes a crown gear for a crown gear drive as well as a method of producing the crown gear. The crown gear is substantially annular-disc-shaped, with its teeth axially projecting relative to the annular disc. The teeth are produced by a hob cutting process, with the hob cutter moving radially with reference to the crown gear axis and being axially fed in. EP 227 152 B1 shows a similar crown gear which is also produced by hob cutting.

From U.S. Pat. No. 6,129,793 there is known a process of forging crown gears, with the forging tools being produced by spark erosion (EDM). The forged crown gears are annular-disc-shaped.

CH 448 629 discloses a gear, more particularly produced from plastics. It comprises spur teeth and a continuous toothed rim in one side face whose teeth are set back relative to the side face of the gear.

DE 102 35 677 A1 discloses a pair of teeth with a crown gear and a pinion. The crown gear is provided in the form of a ring and comprises a collar whose axial height corresponds to the crest plane of the crown teeth.

DE 43 09 559 A1 discloses an angle drive with a housing in which there are supported a pinion and a gear in the form of plane wheel with face gears.

It is the object of the present invention to propose a crown gear for a differential assembly which permits a lightweight and compact design. Furthermore, it is the object of the invention to propose a lightweight and short differential assembly.

A first solution consists in providing an inventive crown gear which can be made to engage a spur gear and which, more particularly, is suitable for being used in a differential assembly in the driveline of a motor vehicle, comprising an annular toothing portion which comprising a crown toothing with addendum lines, and a hub which axially projects beyond the addendum lines of the crown toothing, wherein, between the crown toothing and the hub there are formed transition portions which adjoin the addendum lines of the crown toothing and change into the hub.

The solution in accordance with the invention is advantageous in that the transition portions between the crown toothing and the hub have a stiffening effect on the crown gear, as a result of which the toothed portion can be given a narrower shape without losing any strength. The crown gear is thus lightweight and comprises a short axial length.

According to a preferred embodiment, the transition portions, seen in a cross-section, adjoin the teeth of the crown teeth, wherein two adjacent transition portions converge towards the hub. Radially between the teeth and the hub there is thus obtained a rib-like structure which increases the stiffness of the crown gear. If viewed in a longitudinal section, the surfaces of the transition portions preferably extend entirely continuously in order to minimise stresses. The term “continuously” is to be understood in the mathematical sense, i.e. the transition portions—in a longitudinal section through the tooth crest—are free from discontinuities or bends. In a concrete embodiment, the transition portions—if viewed in a longitudinal section—are rounded and tangentially adjoin the hub. This measure results in a particularly stiff structure with low stresses. The hub adjoining the transition regions is preferably sleeve-shaped. In the direction opposed to the direction of the crown teeth, the hub can also axially project from the toothed portion, and to achieve a low-stress transition, it is advantageous if the projecting portion comprises a conical outer face. However, it is also conceivable for the projecting portion to be sleeve-shaped and comprising a rounded transition to the contact face.

According to a preferred further embodiment, an annular region of the toothing portion being axially formed between a radial contact face and a plane formed by dedendum lines of the teeth comprises an axial thickness L3 which amounts to between one or two times the modulus of the teeth, i.e. m≦L3≦2 m. More particularly, it is advantageous if the axial thickness L3 of the annular region approximately corresponds to 1.0 times the modulus m of the teeth, i.e. L3=1.0 m. This results in a particularly short crown gear which, at the same time, comprises few stresses in the region of the tooth roots. In a preferred embodiment, the tooth, in their longitudinal extension, comprise a variable cross-section and a variable height relative to the root lines. This approximately corresponds to 2.25 times the modulus m, i.e. L2−L3=2.25 m. The teeth widen radially outwardly in order to ensure a uniform engagement with the teeth of the spur gear. The crown teeth can be provided in the form of straight teeth or helical teeth.

According to a preferred embodiment, the crown gear is produced by a forming operation, with forging or extruding being particularly suitable production processes. Alternatively, the crown gear can be produced by primary shaping, more particularly as a sintered part.

To achieve the above objective, a second solution consists in providing a differential assembly in the form of a crown gear differential, more particularly for being used in the driveline of a motor vehicle, comprising a differential carrier which is rotatingly drivable around an axis of rotation A; two sideshaft gears which are supported in the differential carrier so as to be rotatable around the axis of rotation A; and as a plurality of differential gears which jointly rotate with the differential carrier around the axis of rotation A and which engage the sideshaft gears; wherein the sideshaft gears are provided in the form of crown gears according to any one of the above-described embodiments of the invention and wherein the differential gears are spur gears.

The inventive differential assembly has the advantage of comprising a particularly short axial length because, as a result of the transition portions between the crown toothing and the hub, the inserted crown gears comprise a high degree of stiffness and can therefore be particularly narrow. Furthermore, the axially compact design of the crown gear differential results in a reduction in weight.

According to a preferred embodiment the differential carrier is produced in one piece and comprises opposed openings for mounting the sideshaft gears and the differential gears. This, advantageously, results in a small number of parts, which reduces the production and assembly costs. In a preferred embodiment, the differential gears have inner end faces by means of which they are supported on the hubs of the sideshaft gears towards the axis of rotation. In a further embodiment, the differential gears are supported on a journal which comprises two bearing portions and an intermediate central portion whose cross-section is reduced relative to the bearing portions. The central portion can be entered by sideshafts inserted into the crown gears, so that the length of the components is reduced once again.

A preferred embodiment of the invention will be explained below with reference to the drawings wherein

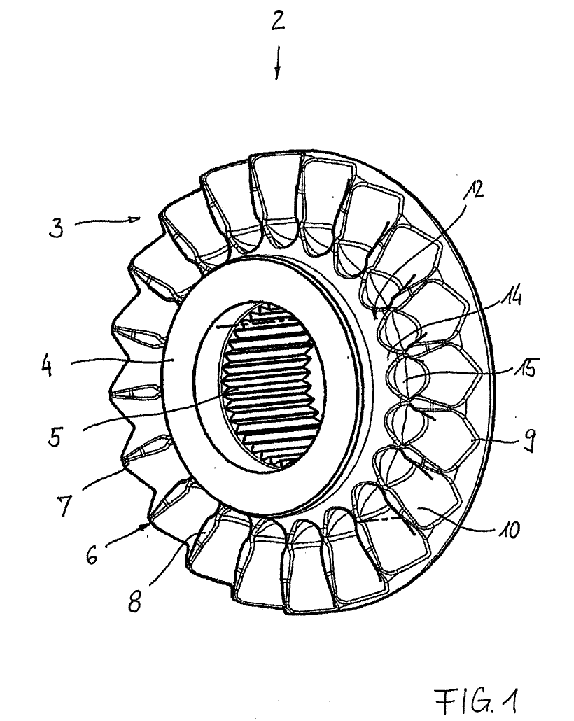

FIG. 1 is a perspective view of an inventive crown gear.

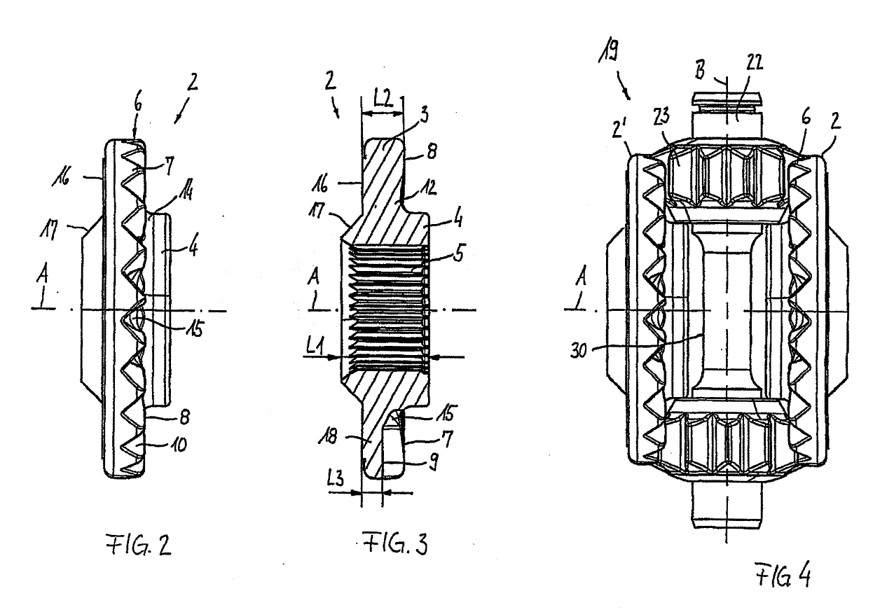

FIG. 2 shows the crown gear according to FIG. 1 in a side view.

FIG. 3 shows the crown gear according to FIG. 1 in a longitudinal section.

FIG. 4 shows a set of differential gears with two inventive crown gears in a side view.

FIG. 5 shows a differential assembly with a mounted set of differential gears according to FIG. 4 in a side view.

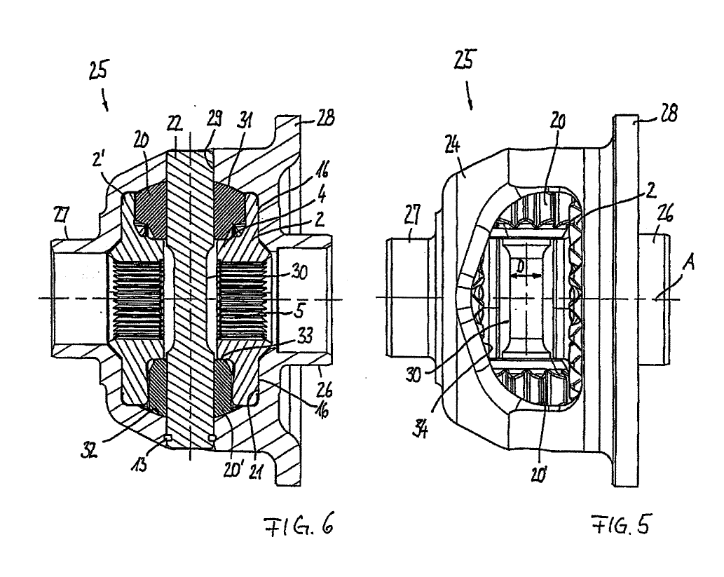

FIG. 6 shows the differential assembly according to FIG. 5 in a longitudinal section.

FIGS. 1 to 3 which will be described jointly below show an inventive crown gear 2. The crown gear 2 is substantially annular-disc-shaped and comprises a toothing portion 3 and a radially inner hub 4 which, by means of a sleeve-shaped projection, axially projects beyond the toothed portion 3. The hub 4 comprises longitudinal splines 5 into which a driveshaft (not illustrated) can be inserted in a rotationally fixed way for torque transmitting purposes. The crown gear 2 is produced by a forming process, more particularly by forging or cold-forging.

The toothing portion 3 comprises, at its face side, crown toothing 6 with a plurality of circumferentially distributed teeth 7. The tooth addendum lines 8 and the tooth dedendum lines 9 of the teeth extend substantially radially relative to the axis of rotation A of the crown gear 2. This means that the crown gear 2 comprises a straight toothing which is able to engage corresponding straight teeth of a cylindrical spur gear (not illustrated). It can be seen that the teeth 7, along their radial extension, comprise a variable cross-section and a variable height. In the radially outwardly extending direction, the teeth 7 widen, with the tooth flanks 10 becoming flatter with reference to the cross-sectional plane. In a radial region between the teeth 7 and the hub 4 there are provided transition portions 12 which seamlessly adjoin the teeth 7 and change into the hub 4. The transitions portions 12 are provided in the form of rounded ribs whose outer faces 14, on the one hand, adjoin the addendum lines 8 of the teeth and, on the other hand, tangentially change into the hub 4. Two adjoining ribs 12 converge towards the hub 4, so that a recess 15 formed between the ribs 12 runs out at the hub 4, with lateral flanks of the recess 15 seamlessly adjoining the tooth flanks 10. The seamless, continuous transitions ensure that the stresses are minimised.

In the direction extending opposite to the direction of the crown teeth 6, the toothing portion 3 comprises a contact face 16 which is positioned perpendicularly on the axis of rotation A and via which the crown gear 2, in the built-in condition, is axially supported against a supporting face. On the radial inside, there follows a conical face 17 which constitutes an outer face of the axially projecting hub 4. The length L1 of the hub 4 is calculated on the basis of the torque to be transmitted and the diameter of the splined connection 5. As already mentioned above, the hub 4 axially projects in both directions relative to the toothing portion 3, i.e. the length L1 of the hub 4 is greater than the axial extension L2 between the contact face 16 and a plane formed by the maxima of the tooth addendum lines 8. Between the contact face 16 and a plane formed by the dedendum lines of the teeth, there is formed an annular region 18 with an axial thickness L3 which approximately corresponds to the tooth height of the teeth 7. Mathematically, the thickness L3 of the annular region can amount of a value between once or twice the modulus m of the teeth, i.e. m≦L3≦2 m. A crown gear which is axially particularly short is obtained if the axial thickness L3 corresponds to one time the modulus m of the teeth 7, i.e. L3=m.

FIGS. 4 to 6 will be described jointly below. FIG. 4 shows a differential gear set 19 in the form of a detail which comprises two inventive crown gears 2, 2′ as well as two differential gears 20, 20′ which engage the crown gears 2, 2′ and which are rotatably supported on a common journal 22. The differential gears 20, 20′ are provided in the form of cylindrical spur gears with straight toothing 23 which engage the crown toothing 6 of the crown gears 2, 2′. FIGS. 5 and 6 show the differential gear set 19 in the built-in condition in a differential carrier 24. The differential assembly 25 formed in this way has to be supported on a stationary housing (not illustrated) of a differential drive. For this purpose, the differential carrier 24 comprises two sleeve-shaped bearing projections 26, 27 which point in opposite directions and on to which it is possible to mount rolling contact bearings. Differential drives of said type are used more particularly in the driveline of a motor vehicle and serve to distribute torque from an input shaft to two output shafts. To permit the introduction of torque into the differential carrier 24, the latter comprises a formed-on flange 28 to which a ring gear can be secured.

The torque introduced into the differential carrier 24 is transmitted to the crown gears 2, 2′ via differential gears 20, 20′ supported on the journal 22 and jointly rotating with the differential carrier 24 around the axis of rotation A. Thereby, expanding forces acting in axially opposite directions are introduced into the differential carrier 24 via the contact faces 16 of the crown gears 2, 2′ which are supported against supporting faces 21. The journal 22 is inserted into radial bores 29 in the differential carrier 24 and axially fixed by a securing ring 13, with other securing means also being conceivable. The journal 22 comprises a central portion 30 with a diameter D which is reduced relative to the bearing portions. Thus, sideshafts inserted into the crown gears 2 in a rotationally fixed way can enter the central portion 30, as a result of which assembly space is saved. When the differential assembly 25 rotates, the differential gears 20, 20′ are loaded radially outwardly by centrifugal forces and, by means of their spherical contact faces 31, rest against a corresponding hollow-spherical counter face in the differential carrier 24. In order to prevent the differential gears 20, 20′ moving radially inwardly towards the axis of rotation A at low rotational speeds, the differential gears 20, 20′, by means of their end faces 33, abut the outer abutment faces of the hub 4 of the crown gears 2. There is thus obtained a simple design with only a few components. The differential carrier 24 is produced in one piece and comprises two opposed openings 34 for mounting the crown gears 2 and the differential gears 20. The inventive differential assembly 25 is advantageous in that it comprises a particularly short axial length because the inserted crown gears 2 comprise a minimum thickness. This is particularly advantageous when the differential assembly 25 is used in a front wheel drive vehicle, where only a small amount of space is available.

1. A crown gear configured to engage a spur gear for use in a differential assembly in the driveline of a motor vehicle, comprising:
an annular toothing portion comprising a crown toothing with addendum lines, and
a hub which axially projects beyond said addendum lines of said crown toothing,
wherein, between said crown toothing and said hub, there are formed transition portions which adjoin said addendum lines of the crown toothing and change into said hub.

2. A crown gear according to claim 1, wherein said transition portions, seen in a cross-section, adjoin teeth of said crown toothing, wherein two adjacent transition portions converge towards said hub.

3. A crown gear according to claim 1 wherein said transition portions—if viewed in a longitudinal section—extend entirely continuously.

4. A crown gear according to claim 1, wherein said transition portions—if viewed in a longitudinal section—are rounded and tangentially adjoin said hub.

5. A crown gear according to claim 1, wherein an annular region formed between an end contact face and dedendum lines of said annular toothing portion comprises an axial thickness (L3) which amounts to between one to two times the modulus (m) of teeth of said crown toothing (m≦L3≦2 m).

6. A crown gear according to claim 5, wherein said axial thickness (L3) of said annular region corresponds approximately to the single modulus (m) of said teeth (L3=1.0 m).

7. A crown gear according to claim 1, wherein, in their longitudinal extension, teeth comprise a height which is variable relative to tooth dedendum lines.

8. A crown gear according to claim 1, wherein in a region adjoining said transition towards teeth of said crown toothing, said hub is sleeve-shaped.

9. A crown gear according to claim 1, wherein in a direction opposed to the direction of said crown toothing, said hub axially projects beyond said toothing portion and comprises a conical outer face.

10. A crown gear according to claim 1, wherein said crown gear is produced by forming, more particularly by forging or extruding.

11. A crown gear according to claim 1, wherein said crown gear is produced by primary shaping, more particularly as a sintered part.

12. A differential assembly in the form of a crown gear differential, used use in the driveline of a motor vehicle, comprising:
a differential carrier which is rotatingly drivable around an axis of rotation (A);
two sideshaft gears rotatably supported in said differential carrier around the axis of rotation (A); and
a plurality of differential gears which rotate jointly with said differential carrier around said axis of rotation (A) and which engage said sideshaft gears;
wherein said sideshaft gears are provided in the form of crown gears comprising:
an annular toothing portion comprising crown toothing with addendum lines; and
a hug which axially projects beyond said addendum lines of said crown toothing;
wherein between said crown toothing and said hub there are formed transition portions which adjoin said addendum lines of said crown toothing and change into said hub;
wherein said differential gears are provided in the form of spur gears.

13. A differential assembly according to claim 12, wherein said differential carrier is produced in one piece and comprises two opposed openings for mounting the sideshaft gears and said differential gears.

14. A differential assembly according to claim 12, wherein said differential gears, by means of their inner end faces, are radially supported on said hubs of said sideshaft gears with reference to said axis of rotation (A).

15. A differential assembly according to claim 12, wherein said differential gears are supported on a journal which comprises two bearing portions and an intermediate central portion whose cross-section is reduced relative to said bearing portions.

16. A crown gear for use in a differential assembly comprising:
an annular toothing portion comprising crown toothing with addendum lines, said crown toothing comprising a plurality of crown teeth;
a hub axially projecting beyond said addendum lines;
a plurality of transition portions formed between said crown toothing and said hub, said plurality of transition portions adjoining said addendum lines and transitioning into said hub;
an annular region formed between an end contact face and dedendum lines of said annular toothing portion, said annular region comprising an axial thickness (L3) comprising one to two times the modulus (m) of said crown teeth (m≦L3≦2 m).

17. A crown gear according to claim 16, wherein said axial thickness (L3) is approximately equal to said modulus of said crown teeth (L3=1.0 m).

18. A crown gear according to claim 16, wherein in a region adjoining said transition portions towards said crown teeth, said hub is sleeve-shaped.

19. A crown gear according to claim 16, wherein in a direction opposed to the direction of said crown toothing, said hub axially projects beyond said annular toothing portion and comprises a conical outer face.

20. A crown gear according to claim 16, wherein said crown teeth comprise a height which is variable relative to said tooth dedendum lines.
